(19) United States
(12) Patent Application Publication
(10) Pub. No.: US 2023/0060983 A1
(43) Pub. Date: Mar. 2, 2023

(54) HYDRODYNAMIC BEARING

(71) Applicant: Wei-yung Lin, Zhunan Town (TW)

(72) Inventor: Wei-yung Lin, Zhunan Town (TW)

(21) Appl. No.: 17/412,246

(22) Filed: Aug. 25, 2021

(51) Int. Cl. F16C 17/02

(52) U.S. Cl. CPC F16C 17/026

(57) ABSTRACT

A hydrodynamic bearing includes a main body. The main body has an inner hole. The inner hole includes a first space and a second space at either end of the first space. An inner wall of the second space is formed with 9-16 hydrodynamic grooves. The hydrodynamic grooves each have a V shape and are arranged at equal intervals. The hydrodynamic grooves each have a bend angle of 30°-50°. The hydrodynamic bearing effectively improves the pressure generating effect of the product and enhances the rotation accuracy of a rotary shaft, meeting the needs of customers.

### BACKGROUND OF THE INVENTION

### 1. Field of the Invention

The present invention relates to a bearing, and more particularly to a hydrodynamic bearing with a good pressure-generating effect.

### 2. Description of the Prior Art

A conventional hydrodynamic bearing generates dynamic pressure action of a lubricating fluid in the gap of the bearing by filling a lubricating fluid in the hydrodynamic groove of the hydrodynamic bearing, thereby supporting a rotary shaft in a non-contact manner. It is suitable for high-speed rotation and has the advantages of high rotation accuracy, low noise and long service life. The conventional hydrodynamic bearing has 8 hydrodynamic grooves defined in the inner wall of the hydrodynamic bearing. FIG. 1 is a schematic diagram of the simulation analysis of dynamic pressure of the conventional hydrodynamic bearing. The distribution of pressure-generating points is scattered, which makes the dynamic pressure-generating effect poor to affect the rotation accuracy of the rotary shaft. Therefore, it is necessary to improve the existing technology to solve the above-mentioned problems.

### SUMMARY OF THE INVENTION

In view of the defects in the prior art, the primary object of the present invention is to provide a hydrodynamic bearing with a good pressure-generating effect, which can effectively solve the problem that the existing hydrodynamic bearing has a poor pressure-generating effect to affect the rotation accuracy of the rotary shaft.

In order to achieve the above object, the technical solutions of the present invention are described below.

A hydrodynamic bearing comprises a main body. The main body has an inner hole passing through front and rear ends of the main body for insertion of a rotary shaft. The inner hole includes a first space and a second space at either end of the first space. The first space has a smooth inner wall surface. The second space has an inner diameter less than that of the first space. An inner wall of the second space is formed with a plurality of hydrodynamic grooves. The number of the hydrodynamic grooves is greater than 8. The hydrodynamic grooves each have a V shape and are arranged at equal intervals. A pressure-generating point is formed at a bend of each of the hydrodynamic grooves. The hydrodynamic grooves each have a bend angle of 30°-50°.

Preferably, the front end of the main body is reduced inwardly to form an annular convex portion. The second space at the front end of the main body extends to the annular convex portion with the same inner diameter. The rear end of the main body is recessed with an annular cavity. The annular cavity communicates with the second space at the rear end of the main body.

Preferably, an outer wall of the main body is recessed inwardly to form a groove. The groove is arranged around the first space.

Preferably, the hydrodynamic grooves each include an outer groove and an inner groove. The outer groove and the inner groove are arranged in a front-to-back direction and communicate with each other. The pressure-generating point is formed at a junction of the outer groove and the inner groove. The inner groove has a length greater than that of the outer groove.

Preferably, the inner diameter of the second space is 1.0-5.1 mm.

In an embodiment of the present invention, the inner diameter of the second space is 3 mm, and the number of the hydrodynamic grooves is 9. In an embodiment of the present invention, the inner diameter of the second space is 3 mm, and the number of the hydrodynamic grooves is 12. In an embodiment of the present invention, the inner diameter of the second space is 5 mm, and the number of the hydrodynamic grooves is 16.

Compared with the prior art, the present invention has obvious advantages and beneficial effects. Specifically, it can be known from the above technical solutions. The inner wall of the second space of the hydrodynamic bearing is provided with 9-16 hydrodynamic grooves, and the hydrodynamic grooves each have a bend angle of 30°-50°, which effectively improves the pressure-generating effect of the product and enhances the rotation accuracy of the rotary shaft, meeting the needs of customers.

Embodiments of the present invention will now be described, by way of example only, with reference to the accompanying drawings.

### BRIEF DESCRIPTION OF THE DRAWINGS

FIG. 1 is a schematic diagram of the simulation analysis of dynamic pressure of a conventional hydrodynamic bearing;

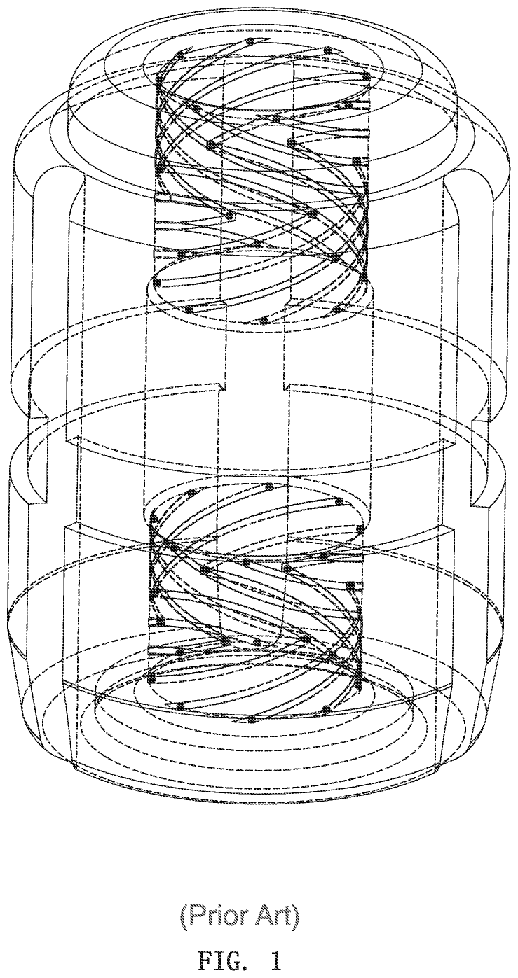

FIG. 2 is a perspective view according to a first embodiment of the present invention;

FIG. 3 is a cross-sectional view of according to the first embodiment of the present invention;

FIG. 4 is a schematic diagram of the simulation analysis of dynamic pressure of the embodiment of FIG. 3;

FIG. 5 is a cross-sectional view of according to a second embodiment of the present invention; and

FIG. 6 is a cross-sectional view of according to a third embodiment of the present invention.

### DETAILED DESCRIPTION OF THE PREFERRED EMBODIMENTS

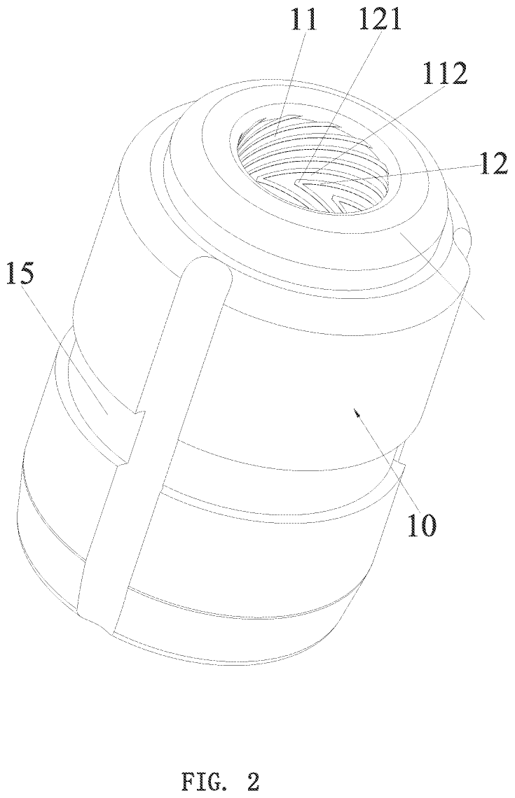

FIGS. 2 to 4 show the specific structure of a first embodiment of the present invention, comprises a main body 10.

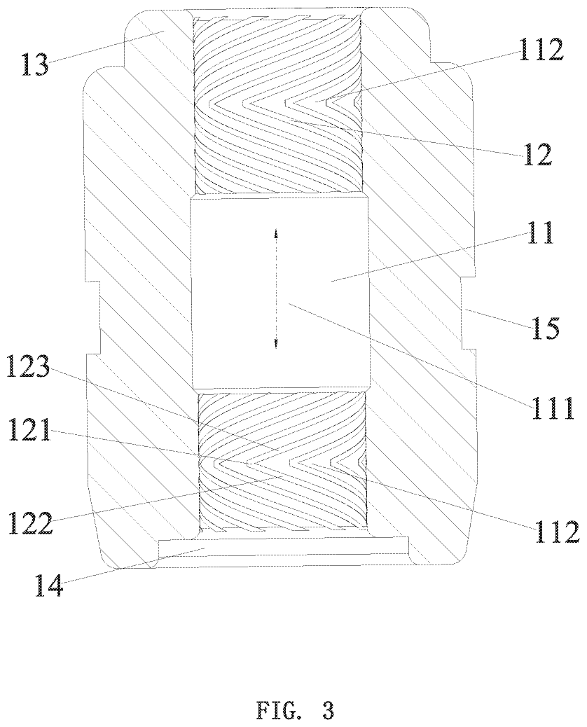

The main body 10 has an inner hole 11 passing through the front and rear ends of the main body for insertion of a rotary shaft, referring to the direction of the double arrow marked in FIG. 3. The inner hole 11 includes a first space 111 and a second space 112 at either end of the first space 111. The first space 111 has a smooth inner wall surface. The inner diameter of the second space 112 is less than the inner diameter of the first space 111. The inner diameter of the second space 112 may be 1.0-5.1 mm. In this embodiment, the inner diameter of the second space 112 is 3 mm. The inner wall of the second space 112 is formed with a plurality of hydrodynamic grooves 12. The number of the hydrodynamic grooves 12 may be 9-16. In this embodiment, there are 12 hydrodynamic grooves. The hydrodynamic grooves 12 each have a V shape. A pressure-generating point 121 is formed at the bend of each of the hydrodynamic grooves 12. The hydrodynamic grooves 12 each have a bend angle of 30°-50°. In this embodiment, the bend angle is 40°. In this embodiment, each hydrodynamic groove 12 includes an outer groove 122 and an inner groove 123. The outer groove 122 and the inner groove 123 are arranged in a front-to-back direction and communicate with each other. The pressure-generating point 121 is formed at the junction of the outer groove 122 and the inner groove 123. The length of the inner groove 123 is greater than the length of the outer groove 122 to reduce lubricant leakage. The outer grooves 122 are arranged at equal intervals. The inner grooves 123 are arranged at equal intervals. The pressure-generating points 121 of the grooves 12 are arranged at equal distances.

The front end of the main body 10 is reduced inwardly to form an annular convex portion 13. The second space 112 at the front end of the main body 10 extends to the annular convex portion 13 with the same inner diameter. The rear end of the main body 10 is recessed with an annular cavity 14. The annular cavity 14 communicates with the second space 112 at the rear end of the main body 10. The outer wall of the main body 10 is recessed inwardly to form a groove 15. The groove 15 is arranged around the first space 111.

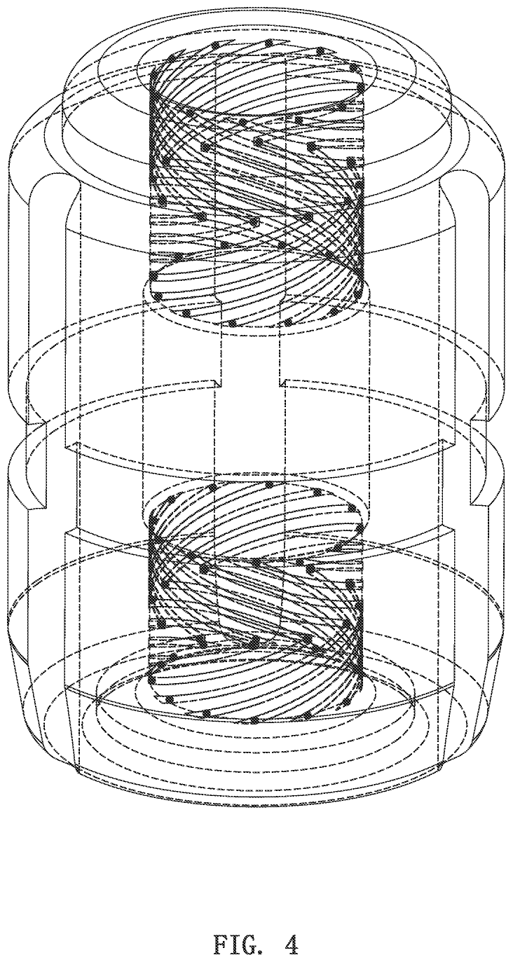

FIG. 4 is a schematic diagram of the simulation analysis of the dynamic pressure of this embodiment. It is obvious that the distribution of the pressure-generating points is concentrated, which significantly improves the effect of dynamic pressure of the bearing. Therefore, compared with the prior art, the present invention has the following obvious advantages:

(1) Prolonging service life: As the number of hydrodynamic grooves is increased by 50% (from 8 to 12), lubricant directly participates in the increase of pressure generation, thereby reducing wear and prolonging the service life. The speed of pressure generation is faster.

(2) Reducing noise: Because there are more pressure-generating points between the surface of the rotary shaft and the inner wall surface of the hydrodynamic bearing, the noise is less when the rotary shaft is rotating.

(3) Support for a higher speed: Due to the pressure-generating support of more pressure-generating points, it can withstand more rotating torque. It is suitable for a higher speed.

(4) Improving anti-leakage: The number of hydrodynamic grooves on the surface of the inner hole of the hydrodynamic bearing is increased, which can prevent the lubricant from being thrown out and can store more lubricant. The working principle of this embodiment is described in detail as follows: By filling the main body 10 with dynamic lubricating fluid, the dynamic pressure of the lubricating fluid is generated in the hydrodynamic grooves 12 and the pressure is generated at the pressure-generating points 121. Thereby, the rotary shaft is supported in a non-contact manner, and the rotary shaft is protected under high-speed rotation.

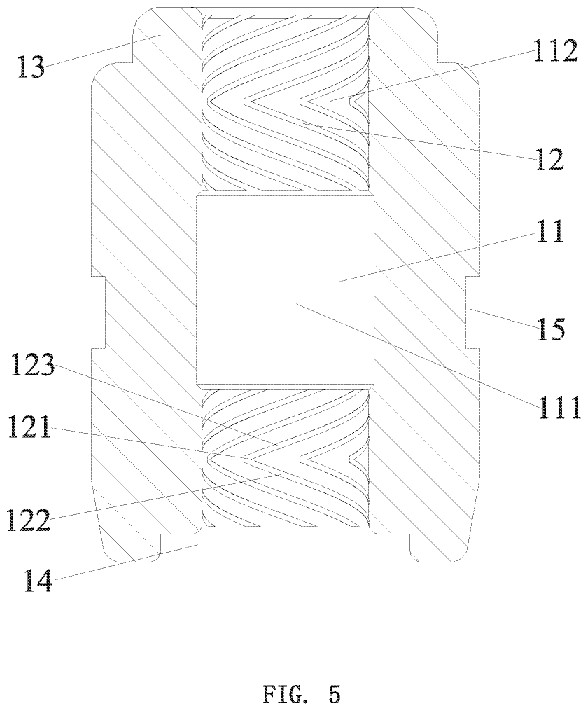

FIG. 5 shows the specific structure of a second embodiment of the present invention. The second embodiment is substantially similar to the first embodiment with the exceptions described hereinafter. The inner diameter of the second space is 3 mm. There are nine hydrodynamic grooves 12 provided on the inner wall of the second space. Through the simulation analysis of dynamic pressure, it can also effectively improve the hydraulic pressure-generating ability of the hydrodynamic bearing. The specific working principle of the second embodiment is substantially the same as that of the first embodiment, and will not be repeated hereinafter.

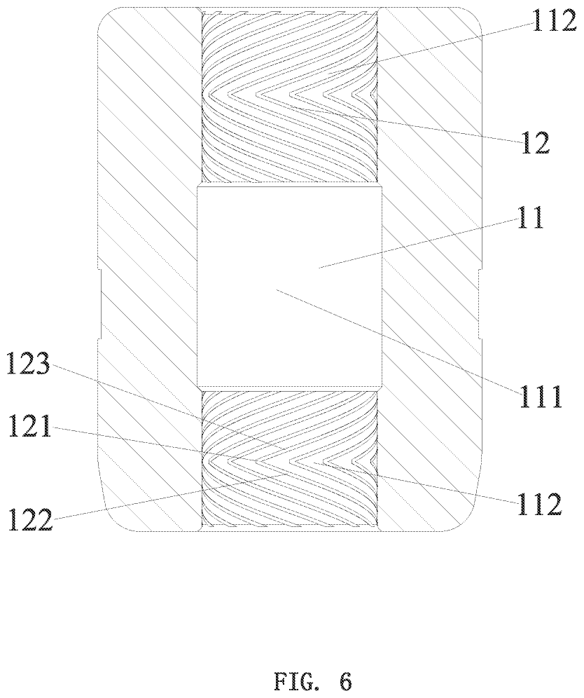

FIG. 6 shows the specific structure of a third embodiment of the present invention. The third embodiment is substantially similar to the first embodiment with the exceptions described hereinafter. The inner diameter of the second space is 5 mm. There are sixteen hydrodynamic grooves 12 provided on the inner wall of the second space. Through the simulation analysis of dynamic pressure, it can also effectively improve the hydraulic pressure-generating ability of the hydrodynamic bearing. The specific working principle of the second embodiment is substantially the same as that of the first embodiment, and will not be repeated hereinafter.

The feature of the present invention is that the inner wall of the second space is provided with 9-16 hydrodynamic grooves, and the hydrodynamic grooves each have a bend angle of 30°-50°, which effectively improves the pressure-generating effect of the product and enhances the rotation accuracy of the rotary shaft, meeting the needs of customers.

Although particular embodiments of the present invention have been described in detail for purposes of illustration, various modifications and enhancements may be made without departing from the spirit and scope of the present invention. Accordingly, the present invention is not to be limited except as by the appended claims.

1. A hydrodynamic bearing, comprising a main body; the main body having an inner hole passing through front and rear ends of the main body for insertion of a rotary shaft, the inner hole including a first space and a second space at either end of the first space; the first space having a non-grooved inner wall surface; the second space having an inner diameter less than that of the first space, an inner wall of the second space being formed with a plurality of hydrodynamic grooves, the number of the hydrodynamic grooves being 9-16, the hydrodynamic grooves each having a V shape, a pressure-generating point being formed at a bend of each of the hydrodynamic grooves, the hydrodynamic grooves each having a bend angle of 30°-50°,
wherein the main body has an inner circumferential surface that circumferentially delimits the inner hole of the main body, the inner circumferential surface comprising a front end segment, a middle segment, and a rear end segment arranged in sequence in an axial direction of the inner hole, the middle segment defining the non-grooved inner wall surface of the first space and circumferentially delimiting the first space, the front end segment and the rear end segment of the inner circumferential surface respectively defining a first portion and a second portion of the inner wall surface of the second space and circumferentially delimiting the second space, each of the first portion and the second portion of the inner wall surface of the second space being formed with at least one of the plurality of hydrodynamic grooves and forming a grooved inner wall surface, such that for the inner circumferential surface of the main body, the two grooved inner wall surfaces of the second space sandwich therebetween the non-grooved inner wall surface of the first space.

2. The hydrodynamic bearing as claimed in claim 1, wherein the front end of the main body is reduced inwardly to form an annular convex portion, the second space at the front end of the main body extends to the annular convex portion with the same inner diameter, the rear end of the main body is recessed with an annular cavity, and the annular cavity communicates with the second space at the rear end of the main body.

3. The hydrodynamic bearing as claimed in claim 1, wherein an outer wall of the main body is recessed inwardly to form a groove, and the groove is arranged around the first space.

4. The hydrodynamic bearing as claimed in claim 1, wherein the hydrodynamic grooves each include an outer groove and an inner groove, the outer groove and the inner groove are arranged in a front-to-back direction and communicate with each other, the pressure-generating point is formed at a junction of the outer groove and the inner groove, and the inner groove has a length greater than that of the outer groove.

5. The hydrodynamic bearing as claimed in claim 4, wherein the outer grooves are arranged at equal intervals, the inner grooves are arranged at equal intervals, and the pressure-generating points of the grooves are arranged at equal distances.

6. The hydrodynamic bearing as claimed in claim 1, wherein the inner diameter of the second space is 1.0-5.1 mm.

7. The hydrodynamic bearing as claimed in claim 6, wherein the inner diameter of the second space is 3 mm, and the number of the hydrodynamic grooves is 9.

8. The hydrodynamic bearing as claimed in claim 6, wherein the inner diameter of the second space is 3 mm, and the number of the hydrodynamic grooves is 12.

9. The hydrodynamic bearing as claimed in claim 6, wherein the inner diameter of the second space is 5 mm, and the number of the hydrodynamic grooves is 16.
